(19) United States
(12) Patent Application Publication
(10) Pub. No.: US 2023/0419240 A1
(43) Pub. Date: Dec. 28, 2023

(54) A CONTAINER DEVICE

(71) Applicant: ILMATURVA OY, Helsinki (FI)

(72) Inventors: Satu AALTO, Helsinki (FI); Juha YLIOLLITERVO, Järvenpää (FI); Kalle KOSKINEN, Helsinki (FI); Ari SIMONEN, Espoo (FI)

(21) Appl. No.: 18/252,989

(22) PCT Filed: Nov. 11, 2021
(86) PCT No.: PCT/FI2021/050764

§ 371 Date: May 15, 2023

(30) Foreign Application Priority Data
Nov. 13, 2020 (FI) 20206153

(51) Int. Cl. G06Q 10/0832; F25D 11/00; B65D 81/38; B65D 43/16

(52) U.S. Cl. CPC G06Q 10/0832; F25D 11/003; B65D 81/3813; B65D 43/16

(57) ABSTRACT

The present disclosure describes systems, methods, and devices generally related to systems and methods for applied wireless communications and, more particularly, to dedicated container devices with intelligence to supervise its content and/or location and state, and accordingly to control the inside conditions inside the container device. Such a container device includes thermal isolation to isolate the container device interior from the outside side of the container device, sensors to measure values, such as temperature, pressure, relative humidity, dewpoint, atmospheric composition, of environmental quantities at least in the container device interior, a communication unit to communicate the measured values of the environmental quantities to an external entities.

### TECHNICAL FIELD

This disclosure generally relates to systems and methods for applied wireless communications and, more particularly, dedicated to container devices with intelligence to supervise its content according to an independent claim directed to such a container device.

### BACKGROUND

Advances in the bio-technical fields, can provide medicament for many diseases and cure to illnesses. Especially such substances that are addressed to large populations, i.e. vaccines can be designed and manufactured, even in a large scale. Some of such substances are easily bio-chemically degradable, when exposed to environmental variations in the ambient conditions.

Outside such conditions in which the substances can be stably stored, the time for the use may expire very rapidly. For some vaccines, the storing temperature may be very narrow, even so narrow as few centrigrades, to preserve the utilizability for the purpose. It is problematic, if only one half of such substances can be used in the original purposes, or the efficiency has been degraded with the expense of the substances' decomposition to provide increased side-effects instead of the original medicament purposes.

This kind of problems has been tried to be solved as certain medicines are mainly transported in traditional refrigerated bags. However, in many cases it is not possible to collect any data to be analyzed about the content of such bag. The inside temperature of the carrier bag can vary widely and the medicines are stored under variable conditions with no uniformed standard, or the user of such a bag just have to trust to be sufficiently fast with the transportation. The required reporting to local authorities is currently done manually on behalf of pharmacies, each in its own way—without uniformity. Sometimes, it is noticed afterwards that the medicines has been spoilt and are beyond of use, the acknowledgement being reached too late and the medicines are lost.

On the part of pharmacists and healthcare professionals, there is a need for a medicine carrier bag whose temperature and other conditions affecting the shelf life of medicines could be standardized and ensured using a new type of technology. The required reporting into a log file, about the prevailing conditions to affect to the medicine in the bag, to local authorities should be easy and uniform for all.

Sometimes sensitive articles such as medicines, vaccines, replacement organs, as well as biological samples just have to be transported from the source location to an institute that has an end-user and would process the sensitive article according to the intended use for medicament, chirurgic purposes and/or study of the article. The sensitiveness sets demands to the transportation to meet, so that the targeted article, or an ensemble of such, would not be spoiled during the transportation. Such articles that comprise biological material can deteriorate, medicines decompose, and living tissues could die, if the article specific transportation conditions are not met for the optimal survival of the articles during the whole transportation. Such mismatch between the required conditions and demands of the article during the transport may occur also because of such conditions that develop during the transportation, independently on the route selection, or the transportation means as such.

Therefore, in such dynamic changes of the conditions in the route, for example, the transporter may have no means to guarantee that the targeted article would be surviving the delays, which may be caused by sudden traffic jam, for example. Sometimes the weather conditions may be setting limits to transportation, because of environmental quantities, such as air pressure drop suddenly, temperature rise/drop, hurricane, flood, crashes etc. for example. Such occurrences are often beyond the predictability, but when developing noticing of such may be in key aspect for the transportation success.

It is therefore important to know the state of the transportation means, to estimate are the optimal conditions maintained during the transport for the target article being transported in the transport media.

The present medical transportations may use during the transport traditional refrigerated bags, from which it is not possible to collect any data to be analyzed, at all. The inside temperature of the carrier bag can vary widely and the medicines are stored under variable conditions with no uniformed standard.

The end user is in a blackout, as well as potentially involved supervising authorities, to whom the state of the transported article is important, in some cases even vital. The required reporting to parties concerned as well as to local authorities is currently done manually on behalf of pharmacies, each in its own way—without uniformity. Accordingly, the reporting may have a history perspective about what was happened, which may be too long in the passed time, beyond the means of restoration the utilizability of the article. For example, an end user in hospital waiting a replacement organ for a patient, gets a report at the transport arrival that the replacement organ was died during the transport because of a traffic accident and a hurricane on the passed route, causing the delay and the consequential loss of the transported replacement organ, possibly the patient, too. Similar situation may be met with medicines as well as other materials that require environmental quantities being kept in certain range during transport.

Similar problems may occur also for other environmentally sensitive articles. For example in industry, military materials, radioactive substance and sources, as well as organo-phosphoric substances may be wanted to be transported in a well-defined transportation media whose internal conditions are not known in the traditional transportation media.

Such problems of the known traditional solutions can be solved by the embodied container device.

An container device according to an embodiment of the present disclosure, comprises
thermal isolation to isolate the container device interior from the outside side of the container device,
means to measure values of environmental quantities in the container device interior,
communication means to communicate the measured values of the environmental quantities to an external entity.

According to an embodiment, a container device can be embodied as a maritime container or similar flight or land transportation container, the cargo container of a truck, van, a traveller's chest, suitcase, bag and/or a handbag. These examples are mentioned as non-limiting examples of the full scalability of the container device size. The container device can be also embodied on wheels in suitable part, to be driven by a vehicle or an artificial intelligence provided robotic vehicle. According to an embodiment, the container device can be embodied as smart container device. Such a smart container device can be used in transport of articles that relate to fields of several industries, i.e. genre, as bio-chemical fields of industry, medical, military as well as safety aspect or risk providing transportations as such.

According to such an embodiment of a container device, with reference to attribute “smart”, an embodied smart container device can detect its interior state in respect of its environmental state, geographic and/or network based location as well as the kinetic state of the container device, in which a change in at least one of the mentioned states or location, considered by the control unit of the smart container device as an initiation, causes at least one response or a series of responses made by actuators of the container device to restore or gain the set values of the states so that the articles inside the smart container device would preserve their utilizability during their presence in the smart container device in question in optimized conditions. According to an embodiment, the container device, including also as smart container device can be a dedicated container device according to said genre, so as for example, as a smart medical container device, etc.

The container device according to an embodiment of the present disclosure can use such environmental quantities being measured comprises at least one of the following interior environmental quantity: temperature, air pressure, moisture, and a derivative quantity of said quantities.

The container device according to an embodiment of the present disclosure comprises means to locate the geographic location/position of the container device. The container device can also comprise means to locate the position of the container device in a building.

The container device according to an embodiment of the present disclosure comprises a radio transceiver to communicate in a report at least one of the measured values of said environmental quantities and the located geographic location/position of the container device.

The container device according to an embodiment of the present disclosure comprises a user interface, in communication to control unit to control the operation of the container device.

The container device according to an embodiment of the present disclosure can be configured to make an alarm to an external entity as a response to an initiation of deflecting values in set environmental quantities in the container device interior.

The container device according to an embodiment of the present disclosure can be configured optionally or in addition to said alarm to constitute counter measures to restore set values of environmental quantities in the container device interior as a response to an initiation of deflecting values of set environmental quantities in the container device interior.

The container device according to an embodiment of the present disclosure can make such counter measures that comprises at least one of the following functionalities to influence to the container device interior environment: a cooling action, a warming action, pressure increase, pressure decrease, a humidifying action, a dehumidifying action, changing the gaseous composition of the container device interior, making an alarm to an operator, suggesting re-routing of the container device transportation, making an alarm to an external entity at the starting position of the transportation, and making an alarm to an external entity at the end user position of the transportation.

The container device according to an embodiment of the present disclosure comprises:
thermally isolated disclosure comprising at least one wall, bottom and a lid that is openable and closable, to define a storing volume for transportation of sensitive medical articles,
a plurality of sensors to define at least one value of the environmental quantities in the container device interior as the environmental state of said storing volume and another plurality of sensors the environmental state of the outside wall of said disclosure,
a dedicated microprocessor entity functionally connected to at least one of the sensors of the each plurality of sensors, to provide environmental data about at least one of the environmental quantities representing environmental states of said storing volume inside and the outside of the wall of said thermally isolated disclosure.

The container device according to an embodiment of the present disclosure comprises communication means connected to the dedicated microprocessor entity, the communication means comprising a transceiver to communicate with an external entity terminal device to provide an access point to one or more external access points to wireless networks for the communication with the container device.

The container device according to an embodiment of the present disclosure comprises configuration to communicate with external entities via information network to determine on-line at least one of the following information at the a predefined route of the container device: outdoor environmental data such as weather information, information from authorities, accident information, road construction information and storm warning information, being available from the information network, on a predefined route of the container device for a transportation of an article in the container device.

The container device according to an embodiment of the present disclosure comprises configuration enabling to receive at least such outdoor environmental data comprising in the following: outdoor temperature, air pressure, moisture, and a derivative quantity of said quantities.

An container device system according to an embodiment of the present disclosure comprises at least one container device according to an embodiment of a container device according to the present disclosure, and a transportation vehicle (105) and/or a larger scale container device according to an container device according to an embodiment of the present disclosure hosting a satellitic container device.

A non-transitory computer-readable medium, according to an embodiment of the present disclosure, storing computer-executable instructions which when executed by one or more processors result in performing operations comprising to provide to an container device functionality being controlled by a control unit.

A transportation method of an article on a preselected route, according to an embodiment of the present disclosure, comprises:
setting for the transportation of said article values of environmental quantities of an container device interior to correspond to demand of keeping the article utilizable after the transportation,
loading article into an container device,
monitoring the environmental quantities of the container device interior,
monitoring information from information networks,
responding to deflection from the set values of environmental quantities of an container device interior by counter measures and/or reporting an external entity about the deflection,
re-routing the transportation on the basis of monitored information from information networks and/or observed deflection from the set environmental quantities, as based on an estimate of delayed delivery of the article.

A smart container device, in the following also referred as a “container device” for brevity, according to an embodiment of the invention presented in the instant disclosure can comprise a number of walls, a bottom and a lid to define a closure with an interior part to store medical articles in the disclosure in the environmental conditions of the container device when being closed. However, the form is not limited only to the shown examples.

According to an embodiment of the disclosure, an embodied smart medicine container device comprises thermal insulation to insulate the closure thermally from the exterior, outside, side of the container device. Therefore, to facilitate conditions that are different inside the container device from outside the container device. The difference being in respect of respective at least one environmental quantity.

According to an embodiment of the disclosure, the thermal insulation is comprised by at least one of the number of walls, a bottom and a lid, to limit the thermal flux between the interior closure of the container device and the exterior side of the container device. The walls and bottom can form a continuum from walls to bottom, so to make round shaped interior and/or outside side closure to provide a smooth operability. The lid can be also integrated to the wall shape for thermally insulating closure. Environmental quantities in question can be temperature, air pressure, relative humidity, moisture content, chemical safety gas composition, for example to mention few, but not necessarily limiting only to the mentioned quantities.

According to an embodiment of the disclosure, the interior side of the container device has a non-zero integer number of compartments so that different medical content can be stored validly in a dedicated compartment within dedicated compartment specific environmental conditions. The exact number depends on the volume of the container device and in other hand from the articles as such to be transported/contained. However, in some embodiments with internal a refrigerator system in the container device may limit the volume for the compartments. According to an embodiment variant, when the number of the compartments exceeds one, the further compartments can be defined by further compartment walls, which can have a thermal insulation to limit the thermal flux between the compartments in the interior closure of the container device, so to preserve the compartment specific environmental state defined by the compartment specific environmental quantities. According to an embodiment, the compartment specific environmental states can differ from each other. According to an embodiment, the further compartment walls are removable to provide versatility to the interior volume of the container device for adaptation to different medical packaging and versatility of them in different transportation tasks. The internal walls may have lip-structure with ridges and recesses at the edges to improve the mutual insulation of the compartments defined by them.

According to an embodiment, thermal insulation has a thickness defined by thermal conductivity to preserve the temperature below certain predetermined threshold, which is bound to the storing temperature of a medical article to be stored in the interior disclosure of the container device. According to an embodiment also vacuum can be used as thermal insulation, although refers in Earth conditions low-pressure gas being used as thermal insulation. According to an embodiment of the disclosure, the thermal insulation has been considered as passive temperature preserving means. In addition, thermal gel can be used as passive elements to store coldness in the compartments of the container device.

According to an embodiment of the invention of the disclosure, the embodied container device has active means to provide a temperature effect to the environmental conditions in the container device interior, at least in one of the compartments in the container device interior. Such a temperature effect can be considered as a compartment specific temperature effect in the dedicated compartment of the interior, in respect of at least one environmental quantity.

According to an embodiment variant, the temperature effect is heating by heating means, being arranged in the control of a control unit to increase the temperature in a dedicated compartment or an ensemble of such. The heating means can be so used to keep the temperature of the medical articles above a critical dedicated medical article specific temperature to prevent deterioration of the medical article. According to an embodiment, the heating means, considered as heater, can be implemented by means of an electric resistance, formed as a resistor foil for example on at least one of the walls or inside such, at the bottom or lid in suitable part defined by the compartment division. According to an embodiment, the heater can be a loose peripheral battery operated element being considered under control of the control unit. According to an embodiment, also magnetic eddy current based heating can be used in suitable part with the appropriate materials being involved in the compartment structure and outside of it to provide magnetic connection. According to an embodiment, the heating effect can be provided by an infrared heater. According to an embodiment, the heating effect can be used to prevent the freezing of the articles in the container device, if has to be kept in very cold conditions long time, and/or to adjust the relative humidity, and/or dew point inside the container device, considered as whole or in at least a compartment.

According to an embodiment variant, the heating means can be provided by an Indium-Tin oxide foil or similar material foil, to provide transparency for the heating means in applicable extent and part.

According to an embodiment variant, the temperature effect is cooling by cooling means, being arranged in the control of a control unit to decrease the temperature in a dedicated compartment. The cooling means can be so used to keep the temperature of the medical articles below a critical dedicated medical article specific temperature to prevent deterioration of the medical article. According to an embodiment, the cooling means, considered as cooler, can be implemented by means of a Peltier element, formed as an element foil for example on at least one of the walls or inside such, at the bottom part or lid in suitable part defined by the compartment division. According to an embodiment, the cooler can be a loose peripheral battery operated Peltier element being considered under control of the control unit. In some embodiments, the cooler can be provided by a refrigerator comprising a compressor. In such embodiments, the temperature can be maintained to freezer, for such transportable articles that require frozen state during the transport. The temperature depends on the insulations of the container device, but down to minus to minus 40 centigrades can be achievable. Aerogel can be used in the insulations, so to provide more volume for the transportation articles.

According to an embodiment, the heating means as a heater and the cooling means as a cooler can be used under control to keep the inside temperature of the container device constant in a threshold defined temperature band, which may be narrow. However, it is clear, that the heater and cooler may operate against each other, in such certain conditions to keep a constant temperature for an arbitrary so demanding article.

According to an embodiment, the cooler and/or the heater can be powered by an external source by cabling to the container device from a vehicle power source, for example. In addition, magnetic inductive coupling can be used for energy delivery by a docking station designed for the container device. According to an embodiment, the container device is a container device of such a container device system that comprises a docking station to provide the power to the container device, by quick couplers, cables with connectors and/or inductive coupling, resembling cellular smart phone charging.

According to an embodiment variant, the container device can comprise also a pressurizing unit as a pressure adjustment means to adjust the pressure of an interior compartment of the container device. For example, transportation in a vehicle, over a mountain route, or because of local weather conditions, the ambient air pressure may vary, providing an effect to the boiling point of liquids in decreased pressure conditions, to decrease the boiling point. Such might be critical for the medical articles during such a transportation, and may adversely affect to the composition of the transported article if not compensated. Therefore, in an embodiment variant the container device can have a pressurizing unit, arranged to increase the pressure in a compartment in the interior of the container device. According to an embodiment variant, the pressurizing unit can be implemented by a release valve being controlled by the controlling unit to control release of gas composition to a container device compartment, from a pressurized gas container, containing a pressurizing agent. A pressurizing agent can comprise carbon dioxide, noble gases, nitrogen, and/or air. Alternatively, the pressurizing unit can be implemented by a blower or fan, and a filtration unit to provide clean air taken from the external side of the container device.

According to an embodiment variant, the pressurizing unit comprises a functionality to decrease the pressure, which can be implemented by a suction function to suck air from the interior of the container device. According to an embodiment, the pressurizing unit can be controlled by the controlling unit, as based on the pressure data being measured by a pressure sensor in at least one of the compartments of the container device, but also at the outfit of the container device to provide pressure data at the external environmental conditions. The thermal fluxes can be controlled by labyrinth channels with heat/cold restoration by thermal energy exchanger structures.

The pressure of the container device can be monitored by the control unit, in a similar way as the temperature by the temperature sensors inside the container device and outside the container device on its outfit.

According to an embodiment variant the container device has an accelerator sensor and/or a position sensor to reveal the transportation artifacts for stiffing and/or unnecessary other mechanical vibrations potentially dangerous for the medical article in the transportation. Such sensors are functionally read by the microprocessor of the control unit.

According to an embodiment the container device has control unit that has a microprocessor entity to operate and control the container device according to the controlling software to control the container device operations as well as to process and handle measurement data about the environment quantities of the container device interior compartments as well as the exterior environment outside the container device.

According to an embodiment as non-limiting examples, a medical article can be medical powder, medical composition with solid, liquid, gaseous or an aerosol form, a vaccine, antibiotic substance, living microbiological sample or vaccine, an organ, to be transported in a container device in its compartment during a transportation time on a predetermined route defined by the control unit settings at the beginning of the route or at a deviation point on the route being still left.

The control unit in an embodiment comprises also a memory as a volatile memory in use of the microprocessor at least during the transportation. The control unit can comprise also a permanent memory in use of the microprocessor during the transportation, to be used as a data logger as well as a storage to save, read and update the operation parameters of the container device, including also the threshold values for the environmental quantities being measured for compartments of the container device embodied. In addition, data about wireless communication to external entities can be stored as well as authentication data about the external entities.

Such environmental quantities are for example, temperature, pressure, relative humidity and derivable quantities thereof, such as derivatives of such to express changes in the environmental conditions, to be used in controlling of the container device operations during the transportation the medical articles in the container device.

According to an embodiment, the control unit has been programmed by the control software settings into a self-evaluation mode, to estimate how long the container device in a dedicated compartment can hold the conditions in the environmental threshold values in the container device for the specific compartment or a group of such. The time can be evaluated by the consumption of the power that is known by the environmental state preserving means to preserve the environmental quantities inside the container device. When the insulation material is known as well as the thickness in the closure, walls, bottom and lid, the control unit can estimate how long time such a temperature difference can be maintained as at the transportation starting site. The estimate can be based on history information stored from the previous transportation sessions into the memory. Such data can be used to define a dedicated smart medical container device profile for the individual container device. The time estimate can be further updated, when there is a planned route, so to provide information about the weather, elevation as well as rush hours that may guide to further change the routing.

According to an embodiment, the communication means comprised in the smart medical container device are programmed to communicate with weather stations, as well as other sites to provide traffic information, in the Internet, to provide weather information about the environmental quantities on the route of the container device and/or traffic information on the planned route of the container device. According to an embodiment, the container device is programmed to request power from an external power source, and/or passive cold elements, for preserving the environmental state in the container device. The request can be based on the dedicated profile of the container device individual, and/or measured environmental conditions, when the control unit knows in the memory the thermal conductivity of the insulation and the thickness.

According to an embodiment of the disclosure, the control unit has a reporter device being embodied as a software means being run by the microprocessor. The reporter device (also reporter for brevity in the following) has been set to keep a log file of the container device about the prevailing environmental conditions as measured by the sensors concerning the environmental sate in the interior as well as exterior side of the container device, so to detect anomalies and their duration during the transportation of the medical article in the container device. In addition, the position and acceleration states can be reported. The reporter has been programmed to make a notification in a notification message being communicated to the entity being responsible for the transportation. In the communication, communication means (as a transceiver) are used under the control of the control unit. The time estimates are also communicated, according to an embodiment variant.

According to an embodiment the control unit has a functional connection to a display arranged to display messages from the controlling unit, which display can be positioned on the container device, but can be embodied, optionally or in addition, as an external display, for example such as a display of the vehicle and/or such of an entity being responsible entity of the transportation.

According to an embodiment, the responsible entity of transportation can be at least one of the following: a sender of the medical article to the transportation, an entity connected to the sending as such, a receiver of the article by the transportation or an entity connected to the receiving as such, a human transporter entity, a robotic transporter entity, a safety organization member, a rescue or emergency organization member, owner of the vehicle and an owner of the medical article.

### BRIEF DESCRIPTION OF THE DRAWINGS

FIG. 1 depicts an example of an embodiment example on an embodied smart medicine container device in an example network environment of a location determination, in accordance with one or more example embodiments of the present disclosure.

FIG. 2 depicts an illustrative diagram for an embodiment of a control unit to control the operation of an embodied smart medicine container device in accordance with one or more example embodiments of the present disclosure.

FIG. 3 illustrates an example of an embodied smart medicine container device as a system element of a system to charge batteries of the smart medicine container device by a charger, to be embodied with one or more example embodiments of the present disclosure.

FIG. 4 depicts examples of the smart medicine container device with actuators according to embodiments of the present disclosure, to be embodied with one or example embodiments of the present disclosure.

FIG. 5 depicts a routing example of an embodied smart medicine container device according to an iterative routing in varying environmental conditions, in accordance with one or more example embodiments of the present disclosure.

FIG. 6 illustrates example of embodied communications of container device, in accordance with one or more example embodiments of the present disclosure.

FIG. 7 illustrates a transportation method example according to an embodiment of the present disclosure in accordance with one or more example embodiments of the present disclosure.

FIG. 8 illustrates an example of an embodiment to follow the container device position as based on uplink GPS services or a like in accordance with one or more example embodiments of the present disclosure.

FIG. 9 illustrates an embodiment of a container device system comprising at least one embodied container device in accordance with one or more example embodiments of the present disclosure.

FIG. 10 illustrates an embodiment of a container device in form of a bag, in accordance with one or more example embodiments of the present disclosure.

FIG. 11 discloses a portable embodiment of the container device in accordance with one or more example embodiments of the present disclosure.

### DETAILED DESCRIPTION

Example embodiments described herein provide certain systems, methods, and devices for a smart medicine container device.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The descriptions about the embodiments are for purposes of illustration and are not meant to be limiting only to the shown examples of embodiments. Numerous other examples, configurations, processes, etc., may exist, some of which are described in greater detail below. Example embodiments will now be described with reference to the accompanying figures.

In communications the smart medicine container device includes, but has not limitation only to, the IEEE 802.11 family of standards, to be used also in location determination and controlling of an embodied medicine container device, in suitable part. However, also other standards may be applicable to particular way of communication.

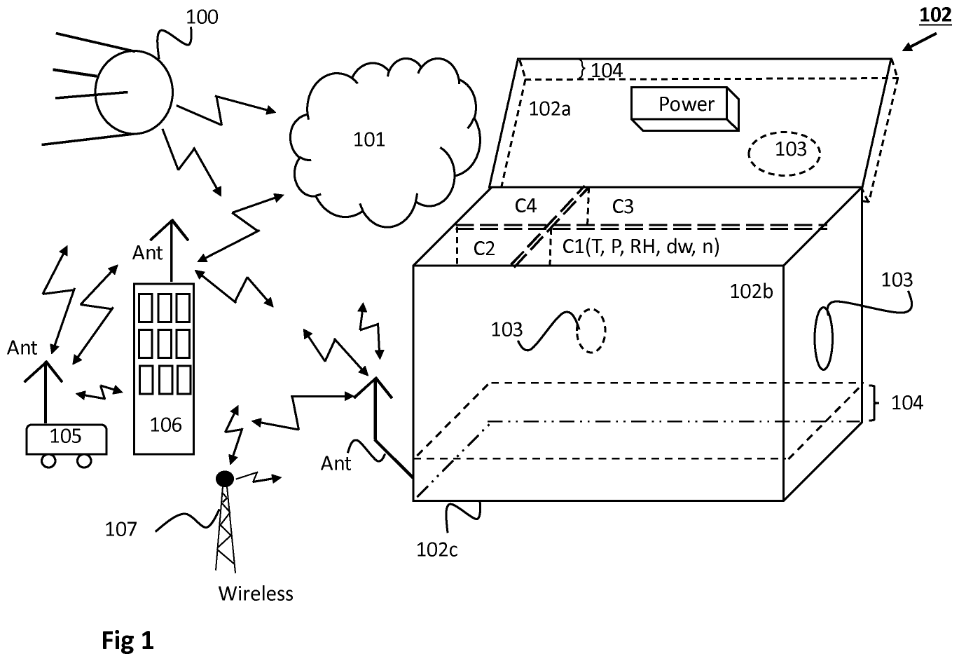

FIG. 1 illustrates a container device 102 (also as container for brevity) according to an embodiment of the present disclosure of the invention. In the FIG. 1, the container device 102 has lid 102a, walls 102b, and the bottom 102c, which have thermal insulating material for thermal insulation, (also shown in FIG. 4 by word insulation). The thermal insulation is for preserving temperature difference between the outside of the container device and the interior side of the container device, when the lid is closed.

Thermal insulation can be made of polyurethane (PU) or similar material, for example. According to an embodiment, the walls as such can be of plastics or similar composite in suitable part, to have the insulation in the walls. Optionally metallic wall materials can be used, which can also provide electromagnetic shielding in suitable part for some dedicated embodiments. According to an embodiment variant, the walls can be plastics or similar composite as such, but optionally coated with aerogel in suitable side or both sides. Although in the example the container device 102 has been embodied as having rectangle walls 102 with sharp edges, and with a hinged exemplary lid 102, the example is not shown with intention to limit the container device or its parts shape only to the schematically shown outfit.

In FIG. 1 there are indicated a division of transportation volume to compartments C1, C2, C3 and C4 by the double dashed lines indicated walls, the dashing indicating optionality and certain versatility to make the compartments in a re-configuration of the compartment volumes. The shown partition is only a non-limiting example; the interior walls can be set otherwise in respect of their number and position. The compartment C1 has been shown in FIG. 1 with a vector (T, P, RH, dw, n) of environmental quantities to illustrate compartment specific environmental state to be preserved in the container device 102. In case of being only compartment C1 in the container device, for the articles to be transported, the vector represents that for the whole free volume of the container device. The reference numerals 103 are indicative to provide a fan for air circulation, as well as intake/exhaust in/out of the container device, so providing also a pressure effect accordingly to the connected container device. If/when divided for a certain purpose to classify different articles to be transported, concerning apparent compartment(s). Blowing air into the container device 102 when otherwise closed, would increase the pressure inside. Sucking air out would decrease the pressure inside the container device, when otherwise closed. Although two fan example locations indicated, the position or the number is not limited only to the shown example. The pressure in the container device can be also set in addition or optionally by a gas container and a connected control-unit-controlled actuator valve.

Pressure sensors as such are not shown for the compartments, although pressure sensors as well as temperature sensors inside can be also positioned to the inside surfaces of the walls and/or bottom to provide pressures and temperatures according to their location, also for the compartments where they are dedicated by the interior wall settings. Such sensors can be used under the control unit to adjust the environmental conditions inside the container device 102.

Heaters and coolers as temperature adjusting elements can be embodied as positioned in to the technical volume. The temperature adjusting element locations can be marked on the bottom of the container device 102, so that the selection of the compartment locations can be better provided according to the interior wall set up to correspond the articles to be transported. That would be found useful, if several articles in different conditions are to be transported and/or different environmental quantity set-ups were required for a selection of different articles in the compartments. The compartment walls can be coated with aerogel for preserving volume for the articles to be transported.

According to an embodiment example in FIG. 1, there is a technical volume indicated by the example near the bottom by a dashed lines defined parallel plane at the distance 104 from the bottom 102c. Although indicated at the bottom, such technical volume can be embodied also into some other part of the container device, in suitable part. According to an embodiment, the technical volume can be embodied as a compartment attachable module to be attached. The power source can be charged by a charger (Ch, FIG. 3) wirelessly in inductive manner. According to an embodiment, technical volume can be located in suitable part to the lid of the container device 102, optionally or in addition to the other embodied location, as indicated by the dashed lines at the lid 102a. The operation power can be taken for the functionality from the power source power, which can comprise a battery for powering an embodied container device, in suitable part. A fan 103 has being also indicated embodied on the lid 102a as a non-limiting example of a fan location.

However, for the embodiment according to FIG. 3, it would be useful to locate the technical volume, or a suitable part of it to the bottom, so that a simple docking can be used by landing the container device 102 onto the docking station Dock. The docking station Dock in FIG. 3 can have a charger Ch, arranged to charge internal power source of the container device. According to an embodiment, for the same purpose can be used also solar cells, external or such integrated to the exterior of the container device walls. According to an embodiment, the charging can be made also by a wired connector, from an external power source, such as a vehicle 105.

According to an embodiment the container device 102 can have one or more antennas Ant for communication with external entities with a suitable communication protocol. The communication can be radio communication, practiced by communication means com as implemented by transceiver means therein of the container device 102. The transceiver can be located to the technical volume, and the antenna Ant to the outside surface of the container device so to provide radio connection to the external entities. A similar antenna Ant has been indicated also being connected to a vehicle 105 to be used in transportation of the container device 102 for communication to further external entities. The one or more communications antennas Ant (FIG. 1) may be any suitable type of antennas corresponding to the communications protocols used by the wireless device(s) with the container device 102. According to an embodiment, an antenna can be hided and/or integrated in to the container device walls.

According to an embodiment, antenna Ant may include one or more directional or omnidirectional antennas, including, for example, dipole antennas, monopole antennas, patch antennas, loop antennas, micro strip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a transceiver of the container device 102, so that such a radio component is to transmit and/or receive signals, such as communications signals to and/or from the wireless devices in communication with the container device 102.

The container device 102 can be configured to make a Wi-Fi connection or similar to the vehicle 105, so not to use the internal resources to the signal strength unnecessarily, although may communicate via suitable wireless protocol to the information network illustrated by the cloud 101 and via it to the connected entities The wireless base station 107 as a wireless link can be used in suitable part in the communication. The transceiver of the container device 102 can be also implemented by an impulse radio in suitable part, i.e. to inform external entities about the changes in the state of the container device interior during the surveillance of the environmental quantities. Any of the wireless devices communicating with the container device 102 may include any suitable radio and/or transceiver for transmitting and/or receiving radio frequency (RF) signals in the bandwidth and/or channels corresponding to the communications protocols in use within the container device 102.

The radio components, such as the transceiver, may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas Ant, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications, where the range to the container device 102 is applicable for such communication. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

The object 106 is illustrating an institution as an example of an external entity. In the illustration, the object 106 can represent the end user institution, to which the container device 102 can communicate its state, according to the reporting set up made by the control unit settings. The communication can be direct, but also in suitable part via redundant channels provided by the vehicle 105 and/or the cloud 101, as well as by using base stations or similar links such as the wireless link 107 being illustrated in FIG. 1.

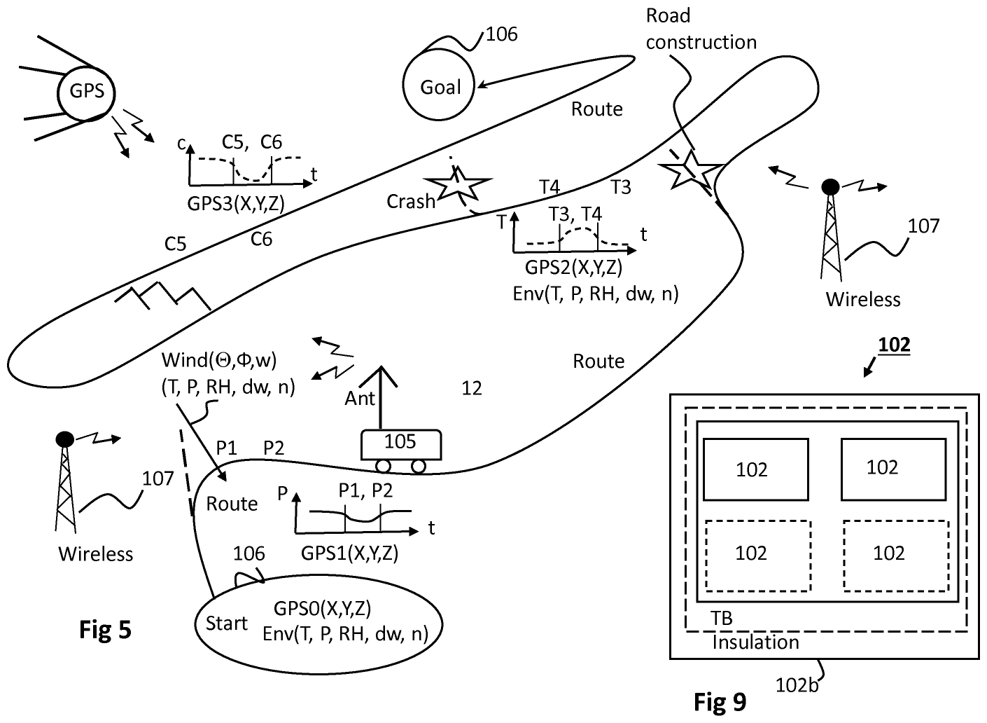

The symbol 100 is representing a satellite location service to be used in addition to the information available from information networks, according to their availability on the route of the container device (cf. FIG. 5), as being carried by a person, or by a vehicle 105. Satellite based container device location determination can utilize any satellite location service protocol, to include GPS, Galileo, Beidou and/or Glonass, to be mentioned as non-limiting examples of satellite based location determination protocols to provide geographic location of the container device. Such location can be also traced by an uplink GPS or similar services.

According to an embodiment variant, the container device can have a gyroscope and/or accelerometer to measure acceleration and consequently forces addressed to the container device, but can be used also to determine the kinetic state(s) of the container device, and their duration when the time information from the processor is available, for example. In FIG. 4 these actuators, gyroscope and accelerometer are respectively referred by the references “Gyro” and “Acce”. The accelerometer as well as a gyroscope can be based on MEMS-techniques by one or several gyroscopes/accelerometers, to provide the orientation information and/or acceleration information in 3D as an additional environmental information. The dashed line has been used to indicate optional functionality for such embodiments. When the weight of the container device and the articles inside are known, also, a near distance location estimates can be formed from the accelerometer data to be used in addition to the other location determination data available, to complete otherwise obtained location information in such a larger scale.

According to an embodiment variant, pressure sensors can be used to estimate the weight of the articles inside the container device and consequently the mass of the articles. According to an embodiment variant, strain gauges can be used as sensors to weigh, as well as piezo electric foil to provide indication about the mass of an article on the foil inside the container device. When the microprocessor entity has connection to the sensor, the information obtained by such sensors can be used in the determination of the container device and its location and/or kinetic state. Accordingly, one example of functionalities of the container device, the sensor can be used to detect, has the container device content changed, and with the information obtained from lock for example, it is possible to define, has there being any tampering or has some one taken without permission something from the container device. In combination to location information, the occurrence can be traced where and when it happened.

According to an embodiment variant, the container device 102 is integrated with a vehicle, which is a robot vehicle. According to an embodiment variant, the robot vehicle can have a satellitic robot vehicle with a container device. A robotic vehicle can be used in transportation of the container device content inside buildings, as satellitic robot vehicle in the corridors of a hospital for example. Such embodiments can be useful in large hospital buildings and/or areas of such. In the navigation to correct end user location, the container device, especially a self-driving and orienting container device, can use maps as well as location determination from several ways according to the embodiments. According to an embodiment, a container device hosting robot vehicle is a car. According to an embodiment variant, the container device hosting vehicle is a drone, integrated with the container device.

FIG. 1 is showing also a network diagram illustrating an example network environment of location determination, according to some example embodiments of the present disclosure. Wireless network provided by the radio communication transceivers may include one or more wireless devices and one or more responding device(s), which may communicate in accordance with IEEE 802.11 communication standards with the container device 102. The vehicle driver can have user device that can communicate with the transceiver of the container device 102. The vehicle driver as well as the container device 102 can communicate with non-stationary (e.g., not having fixed locations) or stationary devices with their wireless devices in applicable part. In some embodiments, the wireless devices, in addition to the container device 102 and its microprocessor entity may include one or more computer systems.

The wireless device(s) participating to the communication with the container device 102 may include any suitable processor-driven device including, but not limited to, a mobile device or a non-mobile, e.g., a static, device. For example in communication with the container device 102 can be used, user device(s) that may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, or the like. According to an embodiment, the container device 102 can use such connections, also IoT connections, also for the locating itself in a building and/or on a route as well as in nearness of the end user and/or transportable article source.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. According to an embodiment, the container device 102 is embodied as an IoT device in suitable part. According to an embodiment, actuators of the container device 102 can be embodied as IoT devices, in suitable part.

An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet.

For example, IoT devices may, in connection to the functionalities of the container device and/or in connection of the further processing of the articles being transported in the container device, include but are not limited to, refrigerators, freezers, air conditioners, thermostats, sensor to determine environmental quantity, inside or outside the container device 102 etc., so long as the devices are equipped with an addressable communications interface for communicating with the IoT network. IoT devices may also include in use of external entity cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity. The articles to be transported can be identified, and information about their properties can be communicated to the container device 102 via an IoT network, at the source location, during the transport and/or at the end user location.

Any of the wireless device(s) may be configured to communicate with the container device 102 in addition to each other via one or more communications networks 101 and/or wirelessly 107 or wired. The wireless device(s) may also communicate peer-to-peer or directly with each other with or without the access point as such. Any of the communications networks 101, 107 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 101, 107 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 101, 107 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

In an embodiment with reference to FIG. 1, the communication means com of the container device 102 may perform location negotiation with one or more external entities 100, 101, 105, 106, 107 (i.e. external to the container device 102). The container device 102 may be considered as an initiating device, also referred to as a station device (STA), and at least one of the other devices such as the wireless link 107 considered as an access point, may be considered as a responding device.

With reference to FIG. 1, an enhanced location service negotiation system may define an enhanced FTM protocol for positioning service between a group of coordinated access points such as 105, 106, (107) and the container device 102. Fine timing measurement (FTM) is a protocol introduced in the IEEE 802.11-2016 standard that specifies a way for two wireless local area network (WLAN) devices to perform round-trip time (RTT) measurements between each other. The container device 102 may be either associated with only one of the access points 105, 106, but may use similar ones in suitable part for to determine their mutual position(s). In one embodiment, an enhanced location service negotiation system may enhance the FTM negotiation to support establishment of an FTM measurement to more than a single access point 105, 106 will. Once a single negotiation is established, the container device 102 may then choose one or more possible opportunities, which may meet their positioning requirements and scheduling constraints. If a positioning measurement is not requested by the container device 102 using the unique ID (UID) or associated ID (AID) on the FTM Resource Request mechanism (e.g. using the Null Data Packet (NDP) Short Feedback for FTM Range measurement) the context is released and a new FTM negotiation needs to be established. It is understood that the above descriptions are for purposes of illustration and are not meant to be limiting only to the shown example.

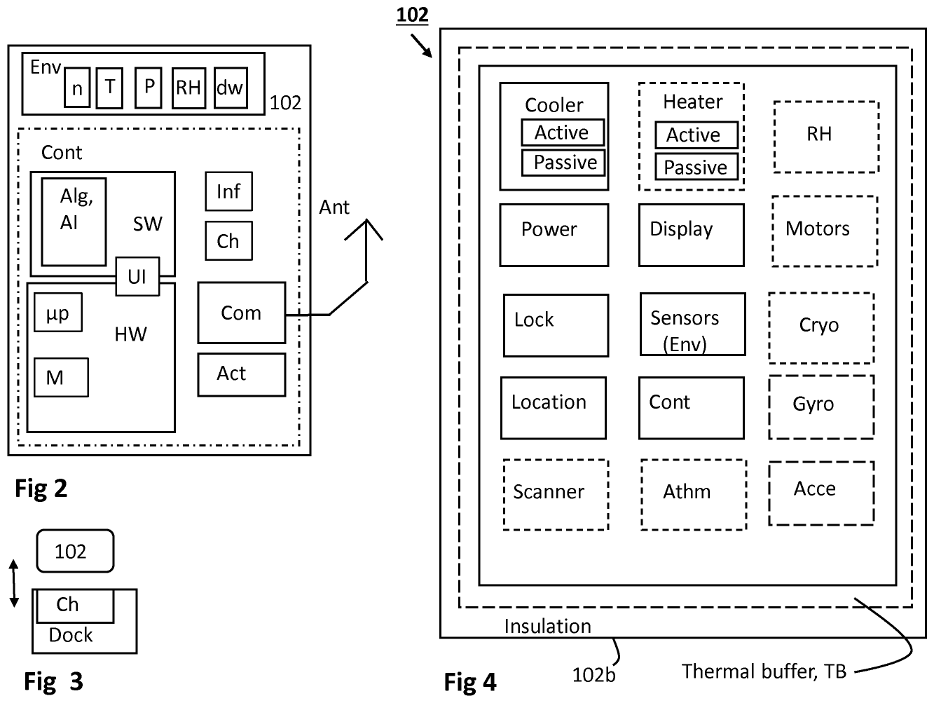

With reference to FIG. 2, the container device 102 has control unit Cont comprising software part SW and hardware part HW. Certain embodiments of the control unit may be implemented in one or a combination of hardware, firmware, and software. Other embodiments may also be implemented as instructions stored on a computer-readable storage device M, which may be read and executed by at least one microprocessor entity lap to perform the operations described herein. As a memory M according to an ensemble of embodiments, computer-readable storage device M may include any non-transitory memory mechanism for storing information in a form readable by microprocessor entity μp. For example, a computer-readable storage device may include read-only memory (ROM), random-access memory (RAM), magnetic disk storage media, optical storage media, flash-memory devices, and other storage devices and media, to be functionally used by the container device 102.

Software can be stored on such a computer readable medium M containing the software SW embodied as instructions where the instructions configure the microprocessor entity lap to carry out a specific operation when in operation of the container device 102. The configuring may occur under the direction of the microprocessor entity lap or a loading mechanism. Accordingly, the microprocessor entity lap is communicatively coupled to the computer-readable medium M when the container device 102 is operating. For example, under operation, the microprocessor entity lap may be configured by a first set of instructions to implement a first software module at one point in time and reconfigured by a second set of instructions to implement a second software module at a second point in time. According to an embodiment the modules can correspond different predetermined phases of the transport of the article in the container device 102.

In addition, the container device 102 has also a number of sensors to provide environmental information Env. The environmental information may comprise information about temperatures (T) in the container device 102 and its compartments as well as outside the container device, pressure (P) in the container device 102 and its compartments as well as outside the container device, as well as the atmospheric composition (n) in the container device or its compartments. These sensors/actuators (n) may measure the ambient gas composition, but may, in addition or optionally, measure also decomposition substances related to the metabolism of the article in the container device 102, in order to make an alarm about a detected thread to the article being transported. Relative humidity RH can be measured, and the dew point dw can be deduced by the microprocessor calculations from the above-mentioned sensor based measurement results. In addition, kinetic state of the container device can be sensed by a gyroscope actuator and/or an accelerometer sensor. Some substances of articles may not tolerate stirring for example, and the level and type of the forces being present can be detected and if found substance specific safety tolerances being exceed by such a sensor, an alarm is communicated to the user/driver and/or an external entity associated to the transport.

According to an embodiment, the software part of the control unit Cont can comprise the algorithms Alg relating to the maintenance of the temperature and the operations in general. The Alg depicts various algorithms for the container device 102 operation, as well as its maintenance and communications. Also such algorithms are depicted by Alg, that are defining reporting protocol and its details about the article and its state during transport, as well as those algorithms that calculate weather condition changes caused effects to the container device instant environment on the current location and/or on the route. So entities involved with the transport of the article can be informed about the time during which the container device 102 can maintain the set of container device-internal environmental conditions inside the container device 102. Such entities involved with the transport of the article can comprise the container device user(s)/driver, end user of the article, sourcing entity for the article, a potential official authority and/or a representative of just mentioned entity. The algorithm Alg can also comprises procedures how to communicate with external weather stations to have weather information on a pre-planned route of transportation, for example. The Alg may comprise also instructional code on that which satellite location determining protocols were used and how switch between them, as well as how to use other type of location determining protocols based on wireless information networks, near or remote from the container device 102.

The software SW may also comprise artificial intelligence algorithm AI to be used in the maintaining the article in the container device in the article's optimal transport conditions defined by the environmental quantities being measured. The AI algorithm may also assist the user of the container device 102 in transport, to calculate optional routings of the transportation and the time optimization to take such optional routing, if/when there were indications in the weather information about unwanted condition, such as thunderstorm or hurricane for example to be met on the pre-planned route.

The AI may monitor the algorithms in use, and calculate simulations about the transport of the article, as well as estimate the article survival related environmental quantities and obtained information from external network stations. The AI can also detect potential situations and their development as well as follow the situation development and report accordingly to the container device user/driver. Such situation may require re-routing the transport, if such situation was observed and/or deduced.

The AI can be used also in user authentication, for example as based on face recognition, voice analysis, finger print and/or other personal measure based recognition markers to confirm the user. For such purposes, the container device may have a camera and/or suitable scanners. The AI can also follow the official announcements so to be preparing re-routing to avoid areas of traffic accidents etc. as based on the news services and common weather stations about the forecasts on the pre-planned and/or re-routed route.

According to an embodiment, the AI can connect the container device via the communication means Com or by wire to a vehicle CAN-channel or similar channel of the system messaging about maintaining the vehicle and its operative condition. Thus, if there were a fault to be deduced as based on the information of the CAN channel, to be detected by the AI algorithm, it can detect and warn the user/driver or other transport involved entity about possible consequences and/or the potential danger to the article being transported in the container device. The AI may also request help for a further transport, if there were a break occurring, or a threat of such to lengthen the transport of the article beyond the capabilities of the container device to keep the article in required condition for its use.

In FIG. 2, the symbol lap is referring to a microprocessor entity lap having a microprocessor or an ensemble of such being in use in the container device 102, in the control unit Cont of the container device 102. The letter M denotes to a computer readable memory, which can be embodied in suitable part by volatile and permanent memory, also by cloud in suitable part about information that is not needed instantly in such conditions where there were no access to the network and the external entities as such.

The control unit Cont can also control the charging (Ch, FIG. 3) of the container device 102 with electric power by the charger Ch. The control unit Cont can also provide the operational commands to the container device infrastructure Inf for connections to external power sources, displays, cameras, speakers as well as locking of the lid of the container device as well as refrigerator for operation when such is present in the very embodiment.

The communication means Com may include communications circuitry and a transceiver for transmitting and receiving signals to and from other communication stations using one or more antennas Ant. The communications circuitry may include circuitry that can operate the physical layer (PHY) communications and/or media access control (MAC) communications for controlling access to the wireless medium, and/or any other communications layers for transmitting and receiving signals. The communication means Com may also include processing circuitry in suitable part, or can use the resource of the microprocessor entity and memory M arranged to perform the operations described herein.

In accordance with some embodiments, the communications circuitry may be arranged to contend for a wireless medium and configure frames or packets for communicating over the wireless medium. The communications circuitry may be arranged to transmit and receive signals. The communications circuitry may also include circuitry for modulation/demodulation, upconversion/downconversion, filtering, amplification, etc. In some embodiments, the processing circuitry of the communication means Com may include one or more additional processors. In other embodiments, two or more antennas Ant may be coupled to the communications circuitry as illustrated by the connection to communication means Com, arranged for sending and receiving signals. The memory M may store information for configuring the processing circuitry to perform operations for configuring and transmitting message frames and performing the various operations described herein. The memory M may include any type of memory, including non-transitory memory, for storing information in a form readable by a machine (e.g., a computer). For example, the memory M may include a computer-readable storage device, read-only memory (ROM), random-access memory (RAM), magnetic disk storage media, optical storage media, flash-memory devices and other storage devices and media.

In some embodiments, with access to the container device 102 by an external entity to the hardware of the container device 102, the communication means Com may be connected to a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, etc.), a wearable computer device, or another device that may receive and/or transmit information wirelessly.

In some embodiments, the container device 102 can comprise a user interface UI, which can include one or more of a keyboard, a display, a non-volatile memory port, multiple antennas, a graphics processor, an application processor, speakers, and other mobile device elements. The display may be an LCD screen including a touch screen. A finger print scanner can be also included in an embodiment variant. The user interface can be used in user authentication implementation with devices above, but user interface can comprise also a lock, which can be used to control the user access to the article inside the container device 102. The lock can be embodied also with remote control via the signals received by the communication means Com, from an involved external entity associated to the transport.

Although the communication means Com may be combined with hardware and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein.

In a networked deployment, the container device 102, by the communication means Com, may operate in the capacity of a server machine, a client machine, or both in server-client network environments. In an example, it may act as a peer machine in peer-to-peer (P2P) (or other distributed) network environments, where applicable during the transportation, including the start at the article sourcing location and/or the article end user location.

With reference to FIG. 2, the control unit Cont includes a microprocessor entity lap (e.g., a central processing unit (CPU), but can include also a graphics processing unit (GPU), a hardware processor core, or any combination thereof), a main memory M and a static memory, some or all of which may communicate with each other via an interlink. The Control unit Cont may further include in its command a power management device Ch, to be used also for charging, a graphics display device, an alphanumeric input device (e.g., a keyboard), and a user interface (UI) navigation device (e.g., a mouse). In an example, the graphics display device, alphanumeric input device. UI navigation device may be a touch screen display.

The Control unit Cont can control via the microprocessor entity lap a storage device (i.e., drive unit being included), a message reporter, a network interface device/transceiver coupled to antenna(s) Ant, and one or more environmental sensors, a global positioning system (GPS) sensor, a compass, an accelerometer, or other sensors. The control unit Cont may include an output controller in connection to the communication means Com, such as a serial (e.g., universal serial bus (USB), parallel, or other wired or wireless (e.g., infrared (IR), near field communication (NFC), etc.) connection to communicate with or control, also one or more peripheral devices (e.g., a printer, a card reader, etc.)).

The memory M may comprise a storage device that may include a machine readable medium on which is stored one or more sets of data structures or instructions (e.g., software) embodying or utilized by any one or more of the techniques or functions described herein. The instructions may also reside, completely or at least partially, within the main memory within the static memory, or within the hardware processor during execution thereof by the microprocessor entity of the control unit. In an example, one or any combination of the microprocessor entity lap, the Memory M with main memory, the static memory, or the storage device may constitute machine-readable media. While the machine-readable medium is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware for the operations and the functionality of the container device 102 making it as smart medicine container device. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the microprocessor entity and that cause the microprocessor entity to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver utilizing any one of a number of transfer protocols (e.g., frame relay, internet protocol (IP), transmission control protocol (TCP), user datagram protocol (UDP), hypertext transfer protocol (HTTP), etc.) to the container device 102. Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others.

In an example, in the communication with communication means Com, an external network interface device/transceiver may include one or more physical jacks (e.g., Ethernet, coaxial, or phone jacks) or one or more antennas to connect to a communications network. In an example, the network interface device/transceiver may include a plurality of antennas to wirelessly communicate with the container device 102 using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the microprocessor entity μp and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

With reference to FIG. 4, the container device 102 has insulation to thermally insulate the interior of the container device 102 and the articles, during their transport, from the external world. The insulation may be made in suitable part implemented by aerogel, to provide a thin insulation layer and consequently to provide more room for the interior volume for the articles, and/or the technical volume. Also poly urethane (PU) or similar insulation materials can be used in suitable layers, the thickness of which being matched to certain predetermined temperature difference between the outside of the container device 102 and its interior, to be maintained by the temperature effect providing means. In addition, vacuum can be used as insulation also in suitable part, as well as gases or liquids to keep the temperature in set values and/or between threshold limits allowable to the article for its preserving in utilizable conditions during the transport.

According to an embodiment a cooler Cooler in FIG. 4 belongs to the temperature effect providing active means. According to an embodiment, the cooler can comprise at least one of the following: an active cooler and a passive cooler. An active cooler can comprise at least one of the following: a Peltier element, a fan, a refrigerator compressor and an evaporator to evaporate gas and/or liquid. The Peltier element can be used also as active heating means, provided that the electric feed line switches the polarity by a switch, which can be in the control of the control unit Cont. Active cooler can be inherent to the container device 102, or an external accessory to be connected to the container device 102 for the use to provide a cooling effect. A passive cooler can comprise a gel in a pouch, bag or similar, to be cooled before the use in container device 102. According to an embodiment a passive cooler can comprise cryogenic material in a cryogenic temperature and/or to be pre-cooled to a cryogenic temperature. According to an embodiment, the insulating layer can be provided partly by a layer as considered as a thermal buffer TB (FIG. 4), capable to store coldness, to be used as such storage of the coldness. The thermal buffer TB has been indicated by a dashed line as illustrated in FIG. 4 to the interior side of the container device.

According to an embodiment, such a layer can form a tank for a cryogenic agent in liquid form, such as liquid Nitrogen, noble gas, for example Argon, liquid air and/or other inert gas in liquid form. A skilled person in the art knows from the embodiment that such a layer can be used also to store warmth with suitable warmth storing agent, such as for example water.

According to an embodiment, a heater (Heater in FIG. 4) belongs to the temperature effect providing active means. According to an embodiment, the heater can comprise at least one of the following: a resistive heating element, an inductive heating element, Peltier element with reversal polarity connection facility and an infrared element.

The technical volume may be ventilated and the waste warmth may be used in a controllable manner ventilated under the control by the control unit for heating the interior of the container device 102, if/when heating would be required for temperature control faster than normal thermal flux through the insulation would provide.

The Display in FIG. 4 can be embodied as the display of the container device 102 on the wall or lid, but can also embodied as a remote display being functionally connected to the container device 102 and its communication means Com. Such remote display may be a computer display of the vehicle and/or a display of an external entity involved to the transportation of the article as a sourcing party, end user party, supervisor and/or safety organization party or a representative of the mentioned parties. Which display options are in use for a particular transportation occurrence, can be set by the control unit Cont according to the selection of the user and/or an authorized entity involved with the transportation, locally or remotely.

The expression Power in FIG. 4 denotes to the powering of the container device. According to an embodiment, the power source can comprise at least one of the following: A battery, rechargeable battery, wired power source from external source, inductively coupled power source, solar cell, and an external docking station coupled power source.

With reference to FIG. 4, the item Lock refers to facility to lock the container device 102. The locking can be controlled via the control unit Cont, so that only an authorized entity can open/close the locking and/or container device 102. A finger print scanner on the container device or connected to such can be used in the recognition of the user to be an authentic authorized user. The locking can be controlled via the control unit Cont, and so according to an embodiment variant by an authorized remote entity being involved with the transportation. The scanner can be embodied as a part of the user interface UI.

The sensors Env(T, P, RH, dw, n) are related to the sensing the environmental quantities such as temperature (T), pressure (P), relative humidity (RH), dew point (dw) and ambient gas composition (n). Such environmental quantities can be measured inside the container device 102, but also outside the container device, representing outdoor local data. The measured data can be used to monitor the article condition during the transportation, as well as if/when met a deflection from the thresholds defining a good health of the article, in respect of at least one of the environmental quantities, to initiate counter measures to restore the conditions before the deflection. The temperature effect providing means as well as other actuators can be used in suitable part in the restoration. A loop-back control can be used in control of the control unit Cont (cf. FIG. 2). The AI algorithm can be used in a self-learning manner to remember what happened and so to prepare for recognizing if such a situation would be about to develop again later. The AI can also estimate how large temperature difference can be provided by the container device and how long in the expected conditions on the predetermined route being left.

The expression Location in FIG. 4 refers to the capability of the container device 102 to determine its location as based on at least one of the following: satellite based location determination, network based location determination, which can be based on the known position of the access points of the network and/or their signal strength and/or the signal frame based timing, and accelerometer based calculations.

The expression scanner refers to biometric identification devices such as a finger print scanner, voice recognition device as well as eyelid or retina scanner.

With reference to FIG. 4, the expression Athm is indicative of such embodied container device 102 variants with interior gas composition making atmosphere, in the control of the control unit, by an actuator or a combination of such to dose via controllable valves substances from a gas tank or a combination of such. For example, easily decomposable articles in the air can be transported in the container device 102 in a noble gas atmosphere, such as argon for example. In such embodiments, the lid should be embodied with suitable tightness to preserve the atmosphere inside during the transport. In addition, gaseous mixtures can be provided for dedicated special needs if required. The pressurizing can be achieved by using suitable valves to close the container device from the outside. Cooling in a need can be then made by Peltier elements, for example. According to an embodiment, also cryogenic temperature can be gained by using cryogenic substances dosed into the container device interior, while adjusting the atmosphere composition. According to an embodiment, a liquefied cryogenic agent is allowed to evaporate via a valve into the container device interior under control of the control unit Cont Suitable cryogenic agents can comprise liquid Nitrogen, noble gas, for example Argon, liquid air and/or other inert gas in liquid form. A tank as a source of a cryogenic agent and/or a passive element in cryogenic temperature has been embodied in FIG. 4 example by the box with text Cryo.

The item RH denotes to relative humidity, which can be also controlled inside the container device according to an embodiment variant. The item RH can be used in combination with the item Athm so to adjust the temperature as well as the composition of the atmosphere in the container device interior.

The expression Motors refers to embodiments of the container device 102 with moving parts of some types shortly discussed in the following. Such parts may be a refrigerator compressor parts, so to provide a freezebox temperatures into the container device 102, i.e. minus 40 to minus centigrades. According to an embodiment, such compressor can be used also for achieving cryogenic temperatures down to −100° C. In addition, the Motors refers also to potential electric motors to provide mobility to the container device on wheels as a robotic vehicle or an alike. The Motors can also refer to such an electric motor or an ensemble of motors that provide(s) to the container device 102 an ability to fly as a drone as based on an ensemble of rotors comprising at least one rotor. According to an embodiment, at least one type of the mentioned motors can be used in the container device, if not all. According to an embodiment the container device is a self-driving vehicle (i.e. item 105 in FIG. 5, where the driver has been replaced by a driver algorithm, as a robotic driver, with a functional access to the control unit Cont) integrated space for the cargo.

With a reference to FIG. 5, it is indicating a route of a transportation of an article in the container device, by a vehicle 105, which is in the example shown along a route on land. The transportation starts at the sourcing location Start, at the exemplary coordinates GPS0(X,Y,Z). The transport is to be made in conditions being defined by environmental quantities indicated by the marking Env(T, P, RH, dw, n). The reference numeral 106 is indicative in that location a sourcing entity as an entity involved with the transportation. The article can be for example a replacement organ, an isotope with short half-life, an organo-phosphoric compound, etc.

In FIG. 5, an embodiment of a container device is embodied with attribute “smart”, so that an embodied smart container device in the embodiment can detect its interior state in respect of its environmental state, geographic or network based location as well as its kinetic state, in which a change in at least one of the mentioned states or location, considered by the control unit of the smart container device as an initiation, causes at least one response or a series of responses made by actuators to restore or gain the set values of the states so that the articles inside the smart container device would preserve their utilizability during their presence in the smart container device in question in optimized conditions restored/maintained. In addition, other embodied features of embodiment examples in the other FIGS. are applicable in suitable part in combination with one or more embodiments of the present disclosure, for illustrating the functionalities of embodiments of the container device as a smart container device.

As immediately observed, the route Route is not the most direct one from the sourcing entity to the end user location Goal. At the point GPS1(X,Y,Z), the container device 102 has noticed that an external pressure was about to drop from the P1, and the AI algorithm was connecting to a local weather station to obtain a forecast on the route. The forecast indicated a stormy wind Wind(Θ,Φ,w) on a route-crossing location, with the speed and direction indicated in the transparencies. The driver changes the route by the suggestion of the container device 102, to avoid the storm, traffic jam, falling trees etc., to be expected, and takes a short cut, as the AI calculates, that there is such a short cut available which does not lengthen the transportation time beyond the utilizability of the article. The pressure at the location P2 restores, and the transportation continues on a new route.

Then, from an official RSS- or RDS-news channel, the container device 102 receives from the information network node 107 a message that there is a road construction just started, and the planned route is not recommended because of very long queues on the road, but the AI algorithm finds from a map a route to go around the road construction site, and calculates that the delivery of the article would be still in time in synergy of the capability of the container device to maintain the values of the environmental quantities in acceptable level.

At the location GPS2(X,Y,Z) the AI notices from the vehicle CAN-channel, that an air conditioning device of the vehicle is broken, and the hot day temperatures may also influence to the temperature of the container device interior, at the moment being as T3. Accordingly, the AI communicate with the control unit to increase the cooler power, and takes current from the vehicle power source via a connector for the Peltier element for required cooling, so that the temperature rise could be eliminated, and the internal conditions of the container device 102 can be kept as set to the values of environmental quantities, the temperature being maintained in T4, near the T3, while the passage continues. The container device 102 sents a report to the sourcing entity at the start location, as well as to the end user location that changes in external environmental quantities was observed, the actuators of the container device were used to restore the environmental quantities to acceptable level, so that the temperature was set to T4, and the article remains in good shape accordingly.

However, the transportation was re-routed once again, but the police radio informs the container device 102 and the vehicle 105 that there was an accident as a truck crashed at a bridge that collapsed. Once again, the AI informs the user/driver, which the just calculated route was not anymore available to the end user location, but there is a turn-around route, which partly goes on a mountain site, while going around the tops. Accordingly, the user has no other choice, but has to increase the speed to make sure that the resources of the container device would be sufficient for the survival of the article in the container device. In a mountain location GPS3(X,Y,Z) the pressure sensor notices gives an indication to the control unit, that the ambient air pressure is about to drop, i.e. the air density to decrease at C5 as well as consequently the air pressure in the container device. The AI notices that the capacity of a fan is not sufficient to deliver air to the interior of the container device, but notice also that there is available argon in a pressure tank, that could be used for restoration of the container device, to complement the needed capacity to meet the set values. Accordingly the user/driver is informed and the AI takes the control of the fan and the valve actuator to restore the pressure conditions in the container device in a feed-back loop, while monitoring the pressure sensors in the container device 102 and dosing the Argon from the container accordingly to restore the air density in the container device to level C6, although with a deflecting from the normal atmospheric composition in the container device. Finally, in FIG. 5, the last turning was because of human error made by the user/driver, but the end user at the location informed the user/driver about the changed location of the entrance of the institute 106 at the corresponding end user location location.

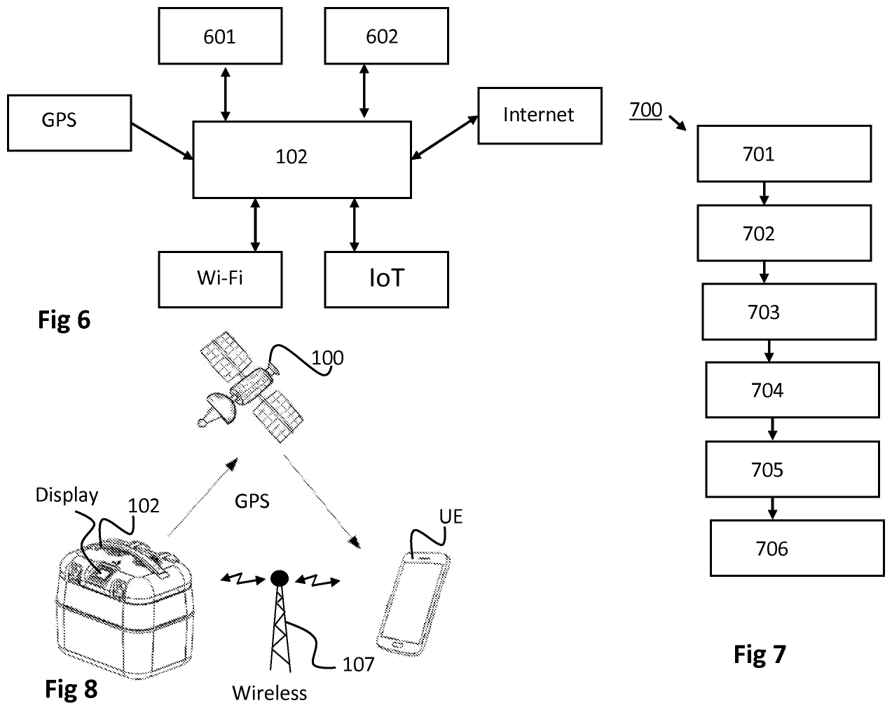

FIG. 6 illustrates communications of the container device 102 according to an example of embodiments. The container device 102 can communicate with information networks 601, for example cellular network comprising base stations. The container device can also communicate with information networks of authorities, RDS-road services, weather stations etc. One of applicable source is the Internet to search information as well as send information about suitable topics to the connected entities involved with the transportation. The container device can also communicate via Wi-Fi as based on client-server protocols, with the vehicle for example, but also with other Wi-Fi access points as well in an applicable part. The IoT networks can be also utilized, in order to find out available resources of connected devices, but also for negotiating further information about the location of the container device. The information network based location determination can be used to support the satellite location determination of the container device, as being illustrated by the GPS. The double headed arrows illustrate possibility to two way communication in suitable part.

FIG. 7 illustrates an example of an embodied transportation method 700 of an article on a preselected route. The method 700 comprises setting (701) for the transportation of said article values of environmental quantities of an container device interior to correspond to demand of keeping the article utilizable after the transportation, loading (702) article into an container device, monitoring (703) the environmental quantities of the container device interior, monitoring (704) information from information networks, responding (705) to deflection from the set values of environmental quantities of an container device interior by counter measures and/or reporting an external entity about the deflection, re-routing (706) the transportation on the basis of monitored information from information networks and/or observed deflection from the set environmental quantities, as based on an estimate of delayed delivery of the article.

FIG. 8 illustrates tracking of the container device by a User Equipment UE as based on wireless radio communication as such. The wireless link 107 illustrates any radio link of a communication network as such, which can be embodied as a cellular network base station, a WI-FI base station or similar access point, to be used in the communication between the UE and the container device 102. Such radio communication can be used in suitable part in the tracking of the container device location and/or status. There is an arrow from the container device to satellite 100 in FIG. 8, to illustrate tracking service of the container device via uplink GPS service as such or a similar service to find out the location of the container device. Other location providing information can be obtained from the networks at the communications signal reach of the container device.

With reference to FIG. 9, there is illustrated a system of container devices 102, in which there are several smaller (satellitic) container devices 102 shown in parallel side by side, to be used in redundantly transportation of mutually similar content and/or transportation of different content in the content, specific conditions inside in each container device. The outmost shown container device has been embodied as a larger container device, to contain in a certain nested way at least one container device 102 inside in its interior. The smaller 102 container devices as embodied do not need to be necessarily identically embodied.

According to an embodiment, the larger container device 102 can be embodied according to an embodiment as a maritime container or a corresponding land transportation container. The smaller container devices can be embodied as handbag sized 102 bag, chest 102, to a van sized container device. However, the size examples are not intended for a limitation, as the container device as such is fully scalable between these example embodiments.

Although embodied container devices can be used in transportation, during which the container devices contain the articles to be transported, in some optional embodiments the embodied container device is used as a stationary non-movable smart container device.

According to an optional embodiment variant, a container device can be embodied as a stationary, non-movable, container device as such as embodied by a room or similar space with the similar operations and same functionalities as any embodied smart container device for transportation, as applicable. The control of the state and conditions is concerning the articles in the embodied container device and the controlling of the environmental conditions inside such, concerning also embodiments with the compartments of the container device as its modules in the non-movable container devices as such. The technical volume can be situated to a cupboard for example. The location determination can be used in authentication information of the location of a non-movable embodiment, so that the other signals coming from the embodied container device can be compared to its pre-determined geographic location, being determined in similar manner as for the location of the mobile container devices.

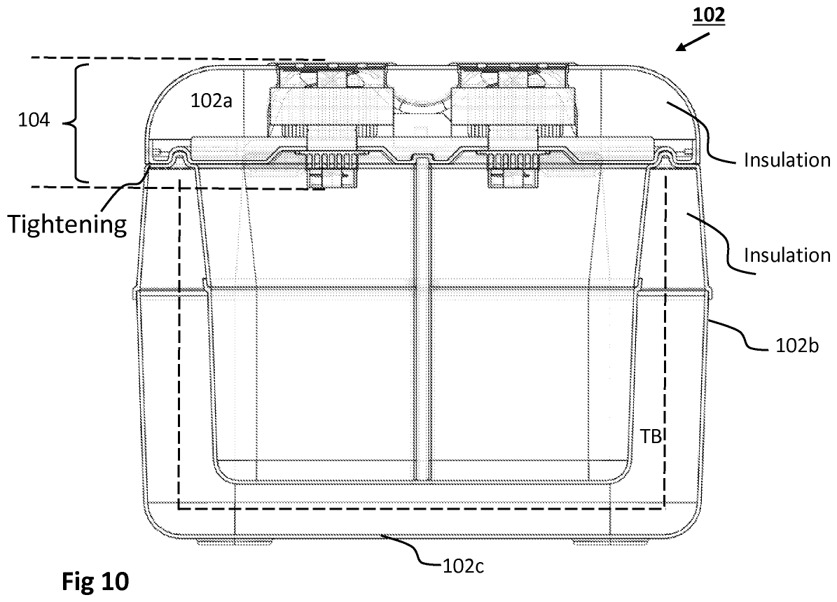

FIG. 10 illustrates an embodiment of a container device in form of a portable bag as a cross section, in accordance with one or more example embodiments of the present disclosure. According to the FIG. 10, the technical volume has been indicated by reference numeral 104, in the embodiment to be located to the lid of the container device 102, in a similar manner as in to the lid in FIG. 1. The walls 102b join to each other with rounded corners in the example of the embodiment. The bottom 102c joins also to the walls with rounded corners. The embodiment example comprises also thermal insulation indicated, as in other embodiments, in suitable part, but can have optionally a thermal buffer TB inside side of the wall of the container device as passive cooling means, so to contain a cooling agent inside it, but in cryogenic container device embodiments a cryogenic agent to keep the interior space and the articles therein in the required temperature, and where applicable, in a controlled manner by the control unit Cont, by using active cooler parts. According to an embodiment, a wireless inductive charging can be mounted also to the container device lid to charge batteries as in FIG. 1 embodied in the lid 102a. The lid 102a and wall 102b surface pair can have a tightening, which can be embodied with a gasket and/or lip or labyrinth ridge-recess formations at the opposing surfaces, so to improve the thermal insulation.

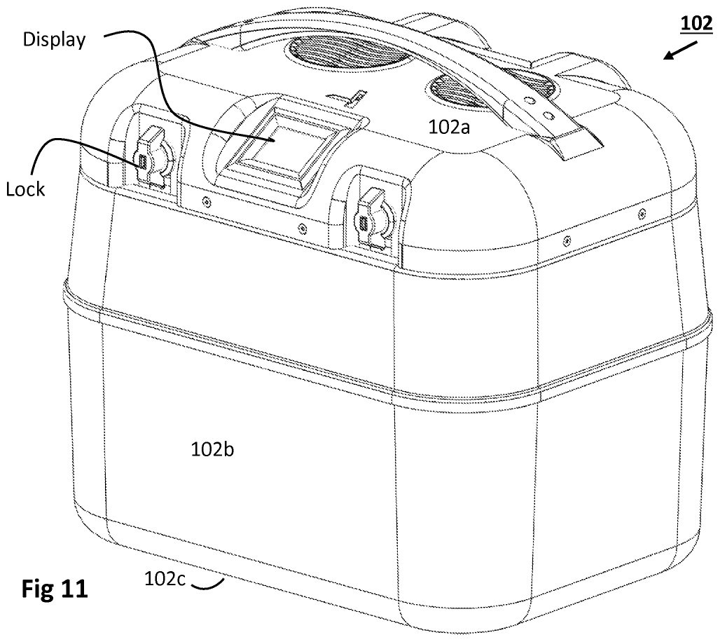

FIG. 11 discloses a portable embodiment of the container device. The container device can be similar as in the FIG. 10, in suitable part. From the view of FIG. 11 also a display and lock has been visibly embodied. The lock operations has been considered further in FIG. 4 example embodiments. The display Display can be embodied as a touch screen type of a display, so representing also an instant user interface to the container device.

### About Generic Terms

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. Similarly, the bidirectional exchange of data between two devices (both devices transmit and receive during the exchange) may be described as “communicating,” when only the functionality of one of those devices is being considered. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit. A transceiver comprises means to transmit as well as means to receive, i.e. respectively a transmitter and a receiver. Such transceivers are used in two-way radio communication systems, but can be used in one-way communication in suitable part.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a microprocessor entity, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

According to an embodiment of the present disclosure, the container device can be scaled to a larger size from a one-person carried container device up to a trunk size or even to a maritime container. Such scaled trunk can be a two-person portable chest, or optionally on wheels rolling container device, for example. An embodied container device can also have thermal insulation to provide a lower interior temperature than −30° C., even lower than −60° C., but advantageously even lower than −70° C. or −80° C., the last two mentioned values being considered as cryogenic temperature values. The thermal insulation thickness can be selected accordingly. By using aerogel in such embodiments as thermal insulation material, the thickness can be embodied very thin, i.e. to correspond temperature difference of 120° C. between the interior and external side of the container device for several hours despite of the penetrating thermal net flux. The temperature difference specific corresponding such thickness depends on the thermal conductivity of the thermal insulation material as such. A skilled person in the art can calculate the required thickness for certain temperature difference being preserved for a temperature in the interior of the container device during a certain time, when the thermal conductivity of the insulation material is known.

According to an embodiment variant, also passive thermal elements can be used as cooling means inside the container device to keep and prolong duration of the temperature in desired values. Such passive elements with coldness storing mass can be pre-cooled to certain temperatures, such as cryogenic temperatures, before their use in the container device. In addition, cryogenic coolant comprising vessels can be used as passive thermal elements to control the interior temperature of the container device.

According to an embodiment, the container device can use an inert gas in liquid form as cryogenic coolant, to provide a cooling effect to the container device interior. Such cryogenic coolants can comprise liquid Nitrogen, Argon, a noble gas in liquid form and/or liquefied air. The cryogenic coolant can be dosed in a suitable portion to (also optionally to a, compartment of) the container device via a valve actuator, such being controlled by the control unit Cont, the controlling being embodied via a loop-back control of the valve actuator in accordance to the measured temperature by the thermal sensors connected to the control unit Cont for the temperature control. In addition, the cryogenic coolant being introduce to the container device can be measured. The effect of the cryogenic material can be based in suitable part also on the evaporation of the cryogenic material, so having influence to the interior atmosphere composition. According to an embodiment, also carbon dioxide can be used in suitable part in cooling.

According to an embodiment variant, the container device has a connection valve for external cryogenic coolant input to be controlled by the control unit Cont, to connect an external source of cryogenic coolant to the connection valve of the container device. The external source can be larger than an optionally embodied internal corresponding cryogenic coolant tank, and can be connected to/off the container device connection valve if needed. Such an external cryogenic tank can be integrated to a transportation vehicle for example. The external cryogenic coolant source can be embodied according to a suitable standard as such. The trunk size scaled container device can be embodied as portable but optionally as a robotic self-driving vehicle on wheels, under the control unit and its AI-algorithm.

According to an embodiment variant, a trunk sized container device well as a maritime sized container device can be scaled so that the embodied container device can comprise inside smaller container devices in a nested way, so to improve the thermal insulation capability to preserve the temperature in an inner container device of the nested container devices (i.e. as in FIG. 9 example, where also redundant smaller container devices as modules has been embodied) in a set value to cryogenic temperature values for example. The communication to the outer world can be provided by an internal radio link, such as WI-FI, for example between the outmost and the inner container device(s), to relay the reports from at least one of the inner container devices to external parties via the outer container device communication means. According to an embodiment variant, the outmost container device can operate as a master, to communicate with the smaller container devices inside. According to an embodiment variant, the communication can be set to mode of operation by packet switched container device dedicated channels, and/or multiplexed communication about the status of the container device system's container devices.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

1. A container device, comprising
thermal isolation to isolate the container device interior from the outside side of the container device,
sensors to measure values of environmental quantities at least in the container device interior,
communication means to communicate the measured values of the environmental quantities to an external entity
wherein the container device is integrated with a robotic self-driving and orienting vehicle to a robotic transporter entity with an artificial intelligence provided robotic vehicle on wheels.

2. The container device of claim 1, wherein the environmental quantities being measured comprises at least one of the following interior environmental quantity: temperature, air pressure, moisture, and a derivative quantity of said quantities.

3. The container device of claim 1, further comprising means to locate the geographic location/position of the container device.

4. The container device of claim 1, further comprising a radio transceiver to communicate in a report at least one of the measured values of said environmental quantities and the located position of the container device.

5. The container device according to claim 1, wherein the container device comprises a user interface, in communication to control unit to control the operation of the container device.

6. The container device according to claim 1, as configured to make an alarm to an external entity as a response to an initiation of deflecting values in set environmental quantities in the container device interior.

7. The container device according to claim 6, further configured to perform counter measures to restore set values of environmental quantities in the container device interior as a response to an initiation of deflecting values of set environmental quantities in the container device interior.

8. The container device of claim 7, wherein the counter measures comprises at least one of the following to influence to the container device interior environment: a cooling action, a warming action, pressure increase, pressure decrease, a humidifying action, a dehumidifying action, changing the gaseous composition of the container device interior, making an alarm to an operator, suggesting re-routing of the container device transportation, making an alarm to an external entity at the starting position of the transportation, and making an alarm to an external entity at the end user position of the transportation.

9. The container device according to claim 1, further comprising:
thermally isolated disclosure comprising at least one wall, bottom and a lid that is openable and closable, to define a storing volume for transportation of sensitive medical articles,
a plurality of sensors to define at least one value of said environmental quantities in the container device interior as the environmental state of said storing volume and another plurality of sensors the environmental state of the outside wall of said disclosure,
a dedicated microprocessor entity functionally connected to at least one of the sensors of the each plurality of sensors, to provide environmental data about at least one of the environmental quantities representing environmental states of said storing volume inside and the outside of the wall of said thermally isolated disclosure.

10. The container device according to claim 1, wherein the container device comprises the communication means connected to the dedicated microprocessor entity, the communication means comprising a transceiver to communicate with an external entity terminal device, to provide an access point to one or more external access points to wireless networks for the communication of the container device.

11. The container device according to claim 1, wherein the container device is configured to communicate with external entities via information network to determine on-line at least one of the following information at the a predefined route of the container device: outdoor environmental data being available from the information network, on a predefined route of the container device for a transportation of an article in the container device.

12. The container device according to claim 11, wherein the container device is configured to receive at least such outdoor environmental data comprising in the following: outdoor temperature, air pressure, moisture, and a derivative quantity of said quantities.

13. A container device system comprising at least one container device according to claim 1, wherein the system comprises a container device as a satellitic transportation vehicle and/or a larger scale hosting container device as a transportation vehicle of at least one satellitic transportation vehicle according to claim 1.

14. A non-transitory computer-readable medium storing computer-executable instructions which when executed by one or more processors result in performing operations comprising to provide to a container device functionality being controlled by a control unit of the container device according to claim 1.

15. A transportation method of an article on a preselected route by the container device according to claim 1, comprising:
setting for the transportation of said article values of environmental quantities of an container device interior to correspond to demand of keeping the article utilizable after the transportation,
loading article into an container device,
monitoring the environmental quantities of the container device interior,
monitoring information from information networks,
responding to deflection from the set values of environmental quantities of an container device interior by counter measures and/or reporting an external entity about the deflection,
re-routing the transportation on the basis of monitored information from information networks and/or observed deflection from the set environmental quantities, as based on an estimate of delayed delivery of the article.

16. The container device of claim 1, wherein the values measured by the sensors are selected from the group consisting of temperature, pressure, relative humidity, dewpoint, and atmospheric composition.

17. The container device of claim 6, wherein the set environmental quantities are selected from the group consisting of temperature, pressure, relative humidity, dew point, and atmospheric composition.

18. The container device of claim 7, wherein the deflecting values of environmental quantities are selected from the group consisting of temperature, pressure, relative humidity, dew point, and atmospheric composition.

19. The container device of claim 9, the environmental quantities are selected from the group consisting of temperature, pressure, relative humidity, dew point, and atmospheric composition.

20. The container device of claim 11, wherein the outdoor environmental data is selected from the group consisting of weather information, information from authorities, accident information, road construction information, and storm warning information.
